(19) United States
(12) Patent Application Publication
(10) Pub. No.: US 2009/0111425 A1
(43) Pub. Date: Apr. 30, 2009

(54) Device and method for category based collaboration and control for mobile communications devices

(75) Inventors: Stephen Kight Forbes, Raleigh, NC (US); Vikram Makam Gupta, Cary, NC (US); Gregory Dunko, Cary, NC (US)

Correspondence Address: WILLIAMS MULLEN, 222 Central Park Avenue, Suite 1700, Virginia Beach, VA, 23462, US

(73) Assignee: Sony Eriscsson Mobile Communications AB

(21) Appl. No.: 11/977,770

(22) Filed: Oct. 26, 2007

(51) Int. Cl. H04M 1/66; H04M 3/00

(52) U.S. Cl. 455/411; 455/418

(57) ABSTRACT

There is disclosed a system, method, and computer readable medium for creating and managing a category based list in a mobile communications device. A category with an assigned category name and a list with an assigned list name associated with a category name are created in the mobile communications device. A set of parameters governing the list is then defined. The set of parameters can include a list expiration date, a group access parameter, group user identifiers, privileges that group users will have with respect to the list, and a check-out time parameter indicating how long a group user can maintain exclusive access to the list. List item can include text items, audio items, video, multimedia, and picture items. Items can be added to lists manually, via a received message or copied from another application. In addition, a list can be checked out for editing by a group user.

### BRIEF DESCRIPTION OF THE DRAWINGS

FIG. 1 is an illustration of some of the internal components of a mobile communications device.

FIG. 2 is a flowchart pertaining to category based collaboration and control for mobile communications devices.

FIG. 3 is a flowchart pertaining to parameters associated with category based collaboration and control for mobile communications devices.

FIG. 4 is a flowchart pertaining to adding items to a list associated with category based collaboration and control for mobile communications devices.

FIG. 5 is a flowchart pertaining to processing group user requests associated with category based collaboration and control for mobile communications devices.

FIG. 6 is an example of a screen shot of a category based list according to an embodiment of the present invention.

FIG. 7 illustrates additional examples of screen shots of a category based list according to an embodiment of the present invention.

### DETAILED DESCRIPTION OF THE INVENTION

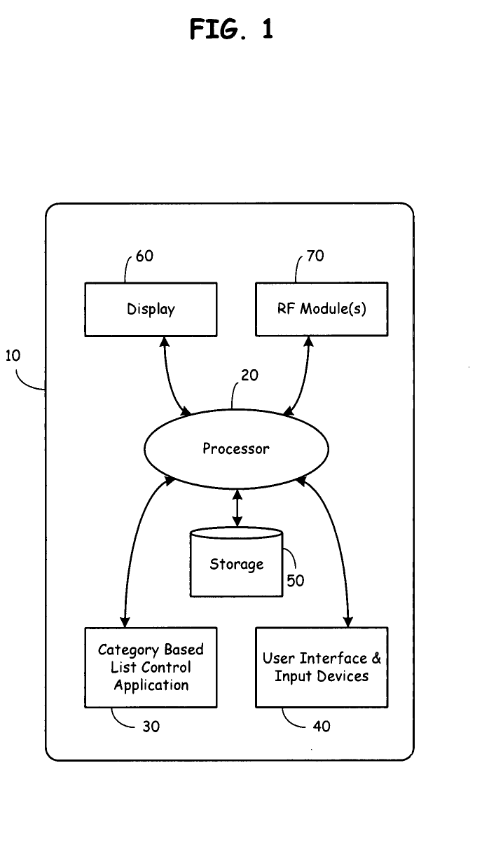

FIG. 1 is an illustration of some of the internal components of a mobile communications device 10. Within the mobile communications device 10 there are included several components that operate to practice the embodiments of the invention. Not all the components that comprise a mobile communications device 10 are illustrated, however. A processor 20 serves to coordinate and control the operations and interactions among the various components. A category based list control software application 30 executable by the processor 20 provides the intelligence for the embodiments of the invention. A block labeled user interface and input devices 40 coupled with processor 20 is illustrated to represent the various forms of obtaining and forwarding input data for use by the category based list control software application 30. Such input can include character, text, audio, picture, and video. A storage device 50 is shown coupled with processor 20 that acts as a repository for data used in the embodiments of the invention. The storage device can be internal or removable or both. While a single storage device 50 has been illustrated, it is quite common that mobile communication devices 10 utilize a plurality of different storage mechanisms at once. Nothing in the description herein should be construed as limiting the data storage options to a single storage device or mechanism. A display component 60 is shown coupled with processor 20. The display 60 provides a means of visual output for the category based list control software application 30. Also shown is an RF module 70 coupled with processor 20. The RF module 70 is utilized by the mobile communications device 10 to send and receive wireless signals for voice and data. The RF module 70 is utilized by the embodiments of the present invention to send and receive data used by the category based list control software application 30 via, for instance, SMS or MMS messaging protocols that are typically within the available features of most mobile communication devices. Other data protocols available to the mobile communications device 10 may be used or implemented by the embodiments of the invention as well.

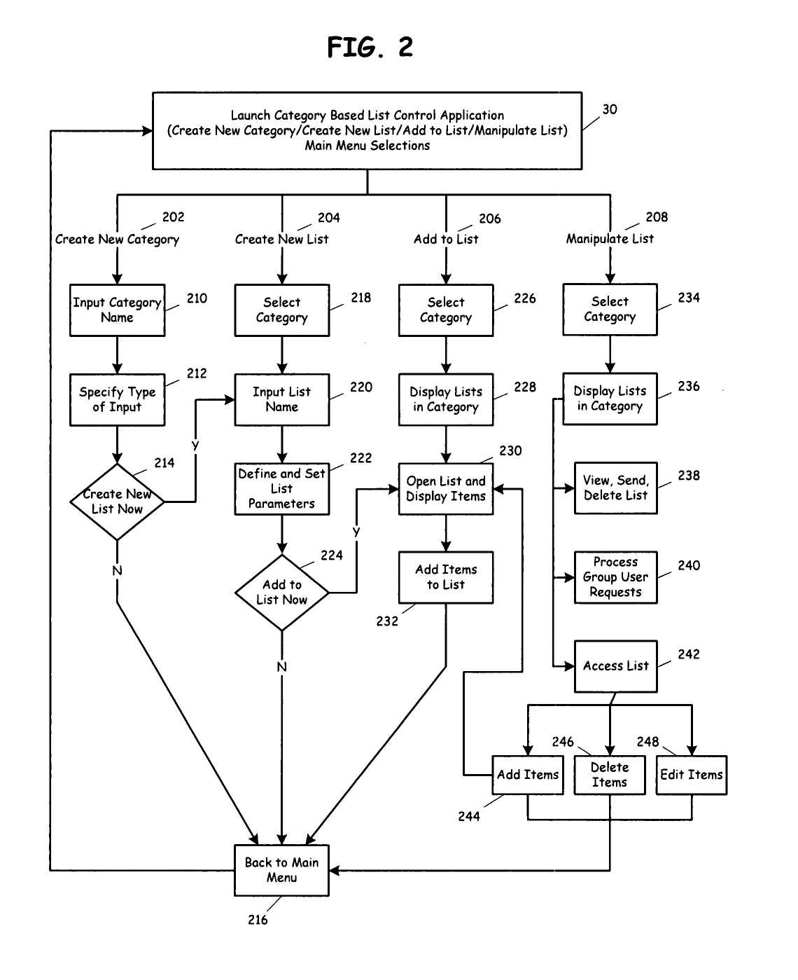

FIG. 2 is a flowchart pertaining to category based collaboration and control for mobile communications devices. The category based list control software application 30 includes four broad functional processes: create new category 202; create new list 204; add to list 206; and manipulate list 208. The software can come preloaded with one or more categories. In addition, the category/list ID could be text, image, URL, or other multimedia.

To create a new category 202 the category based list control software application 30 will prompt the user via the display 60 to input a category name 210. The category based list control software application 30 will then prompt the user to specify the types of input 212 to be associated with the category. Types of input include, at a minimum, text, audio (e.g., voice recordings), video, multimedia (video\audio) and still video (e.g., picture). Once the category name and input types have been received by the category based list control software application 30, a prompt can be displayed asking if the user would like to create a new list now 214. If the response is no, then the category based list control software application 30 terminates 216. Otherwise, control is passed to the create new list functional process 204.

To create a new list 204, the user is first prompted by the category based list control software application 30 to select a category 218 (unless the user is creating a new list upon creating a new category in which case the category has already been selected). Upon selecting a category for the list, the user is prompted to input a list name 220. The next step involves defining and setting various parameters 222 that govern the existence and control over the list. Once the list parameters have been defined and set, the user is prompted by the category based list control software application 30 whether to add items to the list now 224. If the response is no then the category based list control software application 30 terminates 216. Otherwise, control is passed to the add to list functional process 206.

To add to a list, the user first selects a category 226 in response to a prompt from the category based list control software application 30. The lists for the selected category are then displayed 228. The user then uses the user interface tools 40 to navigate and highlight the desired list and that list is then opened and its items displayed 230. The user then follows the prompts of the category based list control software application 30 to add more items to the list 232. Upon completion of adding items to the list the category based list control software application 30 can be terminated 216.

The last functional process allows the user to manipulate a list 208. To manipulate a list, the user utilizes the user interface to select a category 234. The lists in the selected category are then displayed 236. The user can then view, send, or delete the list 238, process group user requests 240, or access the list 242. If the user opts to access the list 242, he will be presented with the sub-options of adding items 244, deleting items 246, or editing items 248. Once the user has completed list manipulation, the category based list control software application 30 can be terminated 216.

An additional feature allows for lists to be pre-populated with items. Such items can be selected or deleted at the user's discretion. For example, there could be a list with item names and a selectable check box. Items left unchecked by the user would be deleted from the list or vice-versa. Also, creating a list enables a “send to” link in other multimedia applications.

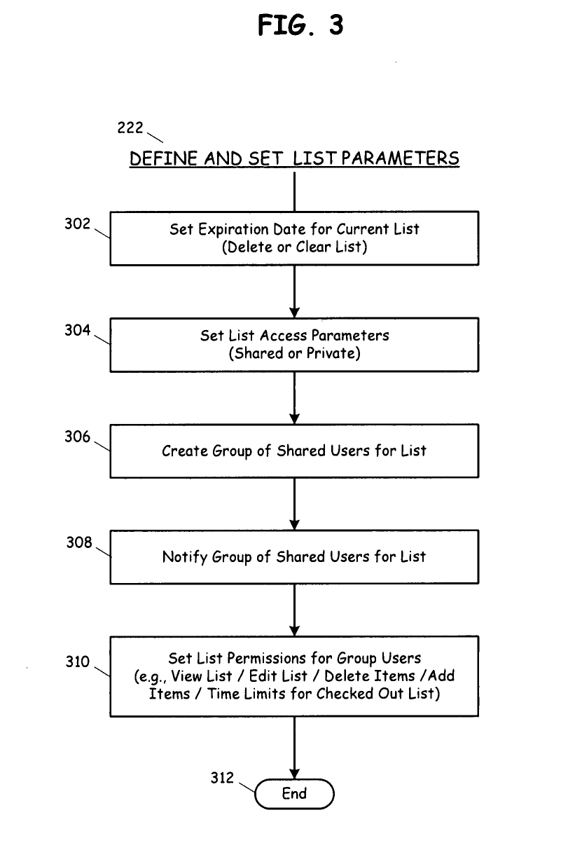

FIG. 3 is a flowchart pertaining to parameters associated with category based collaboration and control for mobile communications devices. In creating a new list 204, one of the steps or processes was to define and set list parameters 222. This includes setting an expiration date for the list 302. “None” can be an option meaning that the list will not expire until the user manually deletes or clears the items from the list. Also, the expiration date can also determine whether the list is to be deleted or whether the items in the list will be cleared but the list itself will be maintained. Another parameter that can be associated with a list is whether it will be a private list or a shared list 304. A private list can only be accessed by the mobile communications device that hosts and maintains the list while a shared list allows for other users of other mobile communications devices (or other computer devices) to access the list contents and manipulate them according to the privileges set by the list creator. If the list is to be shared, the user, via the user interface 40 associated with the category based list control software application 30, can create and identify group users 306 to be given access to the list. Identification can include, a mobile number, an email address, an IM address, a name associated with an entry in the contact database, or other suitable means of identification. Once a group of users has been associated with a list, the members of the group can be notified of the list and their association with same.

For instance, in a family setting, a mother can create a grocery list for the week and invite her husband and the children to access and add to the list. The invitation could be in the form of an SMS message to the group that states, “I'm going to the grocery store on Friday to get the items on the list. Please add your requests to the list before then. Mom.” If the list is created on Monday and expires on Friday evening, the members of the group can add to the list until Friday. Upon expiration as determined when Mom created the list, the items can be cleared so that new items can be input for next week.

The list creator also has the ability to set the permissions and/or privileges group users will have with respect to the list 310. Some of the permissions include viewing the list, editing items, deleting items, adding items, and a time limit for how long a group user can have exclusive access to the list before having to check any changes back in to the list creator.

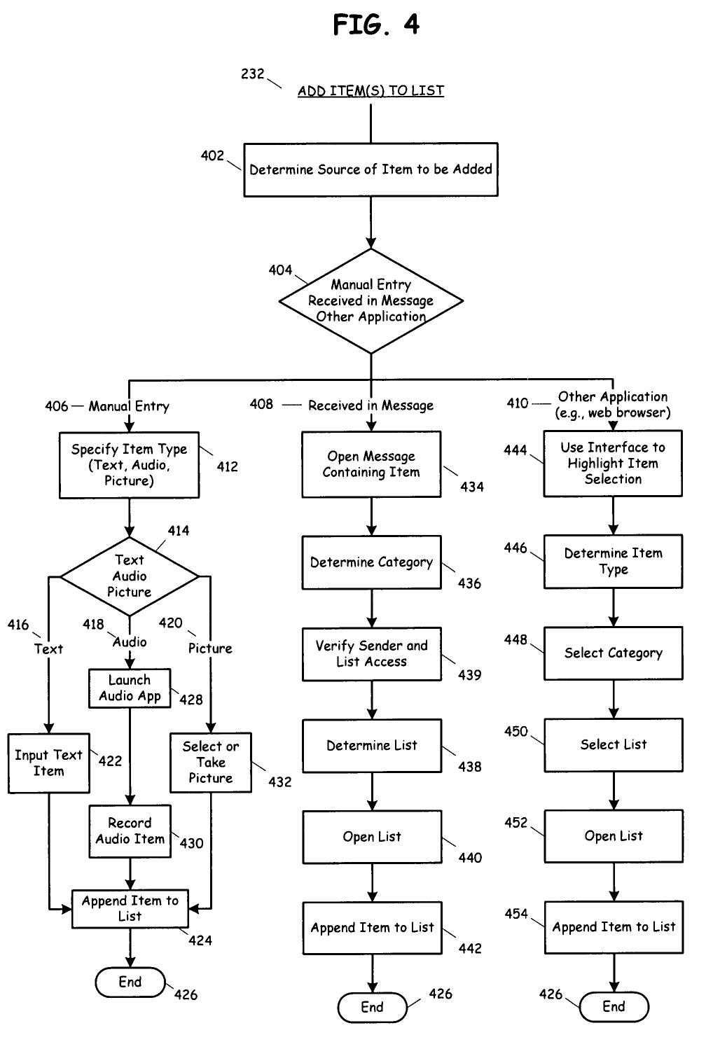

FIG. 4 is a flowchart pertaining to adding items to a list associated with category based collaboration and control for mobile communications devices. When adding items to a list, the category based list control software application 30 determines the source of an item to be added 402. There are multiple source options 404 including manual entry 406, receiving an item in a message 408, and receiving an item via another application 410.

If it is determined that an item is to be manually entered 406, the user is prompted by the category based list control software application 30 to specify the type of item to be added 412. The item type options 414 include text 416, audio 418, and picture 420. For text items 416, the user is prompted to input the text that will comprise the item using the keypad or other input device. When input is complete, the text item will be appended to the list 424. For audio items 418, an audio application such as a voice recorder is launched 428 and the user records an audio item 430 such as, for instance, milk in the grocery list example introduced earlier. The audio item is then appended as the next item to the list 424. For pictures 420, the user can either take a picture using an integrated digital camera (if available) or select a picture image file from a storage device associated with the mobile communications device 10. The selected picture or the picture just taken is then appended to the list 424.

For items received in messages, the user opens the message containing the list item to be added to a list 434. The category based list control software application 30 then determines the category specified in the message 436 followed by the list 438 within the category. The specified category/list is checked to determine group privileges (private/shared) and the source of the message (sender) is then verified as having group access to the specified list 439. Upon verification, the list is opened 440 and the item contained in the message is appended to the list 442.

Alternatively, the program can be coded to recognize messages containing list items and automatically open the message and append the item(s) to the specified list without the user having to open the message manually. In this instance, the user could receive an alert when new item(s) are added to lists.

Items can also be added to lists while utilizing other applications 410. For instance, the mobile communications device user can be browsing the Internet on the mobile device when she comes across a word/phrase or picture that she would like to append to a list. The other application is not necessarily limited to a web browsing application. Word processing applications, spreadsheet applications, contact management applications, file management applications, music applications, etc. can all be the basis for identifying potential list items. When the user comes across a word/phrase or picture of interest, she uses the user interface to highlight or select the item of interest 444. The type of the selected item is then determined 446. The user then must identify the category 448 and list 450 within the category 448 for the item. The list is then opened 452 and the item is appended to the list 454.

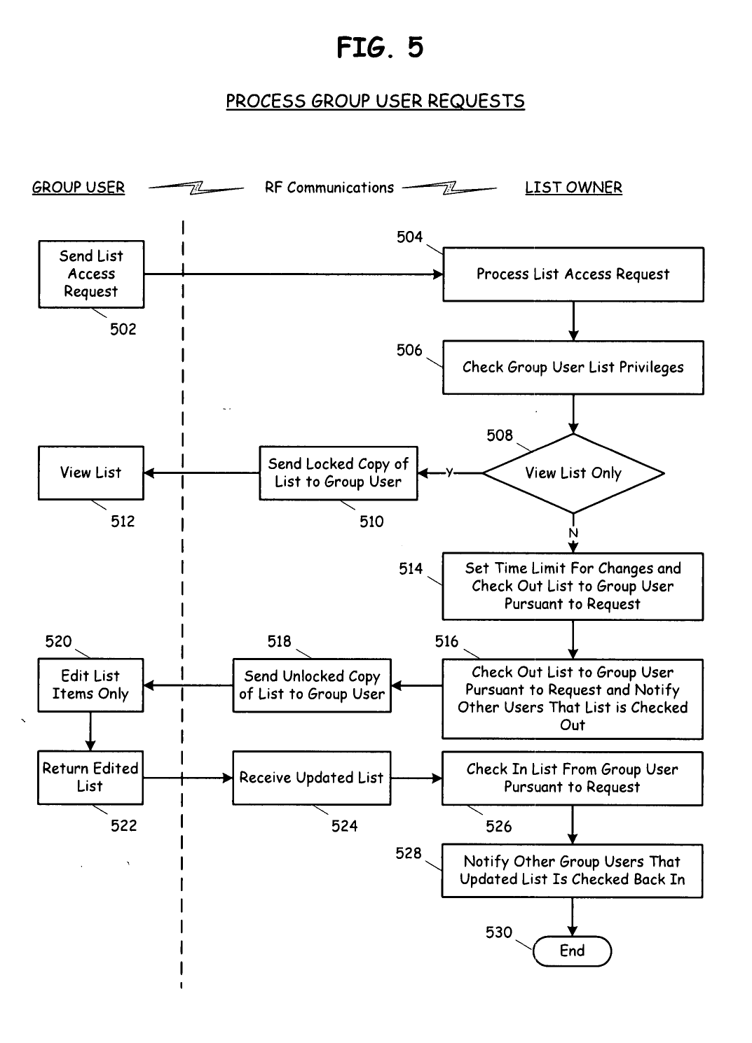

FIG. 5 is a flowchart pertaining to processing group user requests associated with category based collaboration and control for mobile communications devices. Group user requests are received via the RF module 70. A group user will send a list access request 502 to the mobile communications device of the list owner/creator. The list access request identifies the category name and list name of the list to be accessed. The request is received and processed by the mobile communications device of the list owner/creator 504. The category based list control software application 30 checks whether the sender of the list access request is an approved group user for the requested list 506. If the sender is an approved group user, then the level of privileges is determined. If the group user privilege is set at view only 508, then a locked (uneditable) copy of the list is sent back to the requesting group user 510 so that it may be viewed 512. If the group user has additional privileges beyond view only, a time limit is set for the list checkout 514 because only one copy of the list can be edited at a time and only one device can be editing at a time. An unlocked copy of the list is checked out to the requesting group user and the other group users are notified that the list has been checked out and when it is scheduled to be checked back in 516. The unlocked copy of the list is then sent to the group user that made the request 518. That user receives the unlocked copy and may then edit, delete or add list items. The category name and list name parameters as well as the checkout duration time can not be altered by the group user, only list items. Upon completion of list edits, the group user will return the list to the list owner/creator device within the previously specified time period 522. If the list is late in being returned, it will not be recognized. If the list is returned in time it is received 524 and checked back in 526. The list owner/creator has the option of canceling any changes (specifically) deletions made by the group user. Once checked back in, the other members of the group can be notified that the list is available to be checked out again 528.

In another embodiment, it is not necessary to restrict check out of the list to one group user at a time. The list could be open for simultaneous collaboration. If the list is “open” for such collaboration, some form of contention management would be needed, but this is considered to be within the capabilities of those skilled in the art.

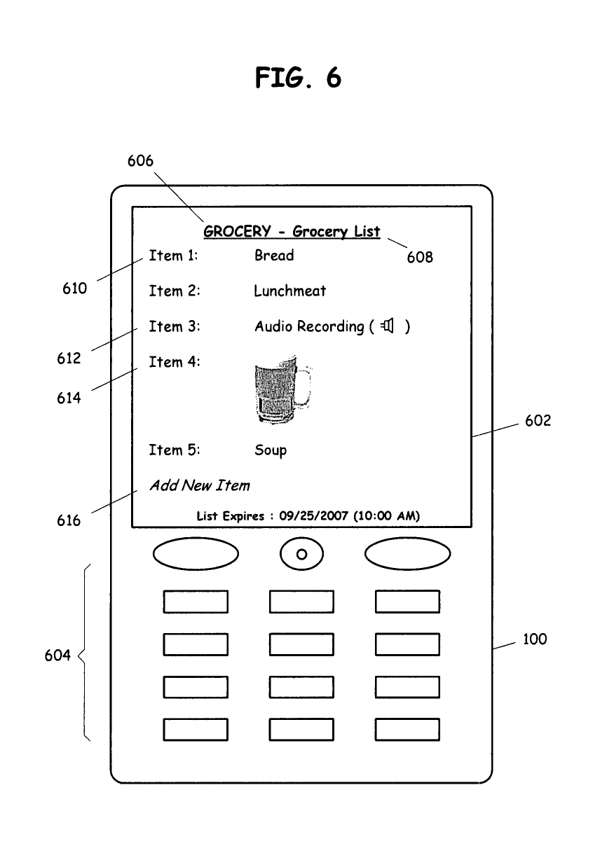

FIG. 6 is an example of a screen shot of a category based list according to an embodiment of the present invention. The display 602 of the mobile communications device 10 illustrates the list. The keys and buttons beneath the display 602 comprise the user input interface and keypad 604. The main heading includes the category name 606 (GROCERY) and the list name 608 (Grocery List). Individual items are then listed. For example, item 1 is a text item 610 “Bread”. Item 2 is another text item “Lunchmeat”. Item 3 is an audio recording 612 as indicated by the speaker icon. Item 4 is a picture item 614 depicting a thumbnail image of a mug of beer. Item 5 is another text item “Soup”. The bottom of the screen includes an option “Add New Item” 616 that can be selected by the user. The list could include additional items that would become visible on the display 602 upon the user scrolling the screen downward via the user interface 604.

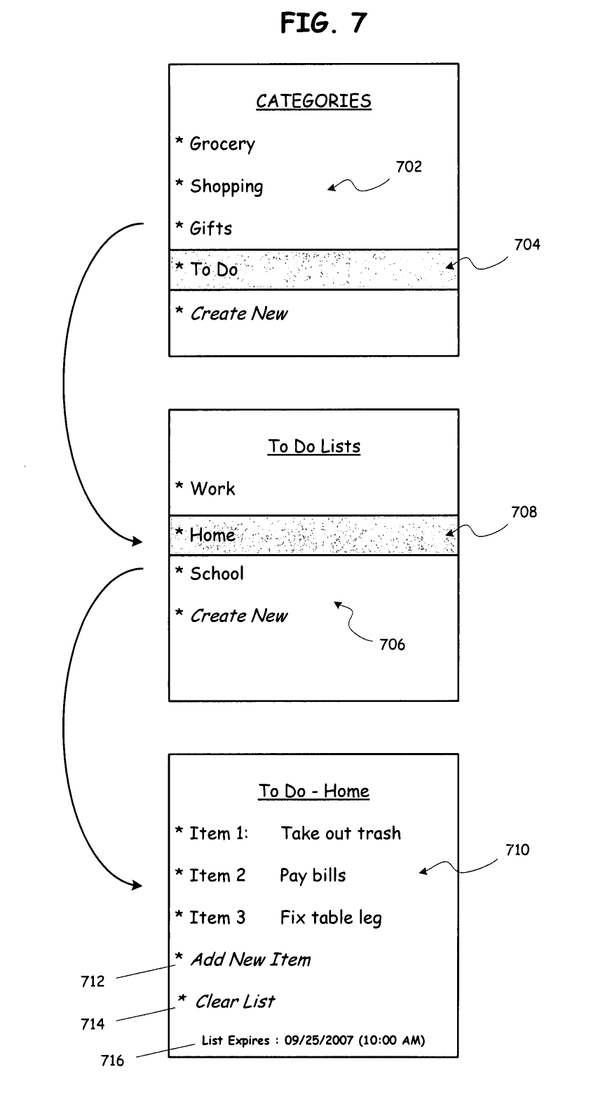

FIG. 7 illustrates additional examples of screen shots of a category based list according to an embodiment of the present invention. The first screen shot 702 is a listing of categories currently available within the category based list control software application 30. In this example, there are four categories of lists: Grocery; Shopping; Gifts; and To Do. Also shown is a selection “Create New” that would allow for the creation of a new category. The category “To Do” appears highlighted 704 in this figure indicating that the user intends to act on this category in some fashion. Some of the options available to the user include editing the name of the category, deleting the category, or selecting the category to view the lists associated therewith.

The next screen shot shown 706 results from the user selecting the “To Do” category on the first screen shot 702. This screen shot 706 provides a listing of the lists associated with the “To Do” category. The list “Home” appears highlighted 708 in this figure indicating that the user intends to act on this list in some fashion. Some of the options available to the user include editing the name of the list, delete the list, view a copy of the list, select the list, or edit the permissions and parameters associated with the list.

The next screen shot shown 710 results from the user selecting the “Home” list on the second screen shot 706. This screen shot 710 illustrates the items associated with the “Home” list under the “To Do” category. Three text items are shown in addition to selections/options including “Add New Item” 712 and “Clear List” 714. At the bottom of the screen, there is shown a list expiration date indicating when the list is set to expire 716. If no date/time is set, then the list will not expire until it is manually deleted by the user. From this screen, the user is free to select an item to edit it or to delete it. The user can also add items or clear the list.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of creating and managing a category based list in a mobile communications device comprising:
creating a category with an assigned category name;
creating a list with an assigned list name associated with a category name; and
defining a set of parameters governing the list.

2. The method of claim 1 further comprising creating one or more list items associated with the list.

3. The method of claim 2 wherein the set of parameters governing the list include one or more of a list expiration date; a group access parameter indicating whether the list is private or shared among one or more group users; one or more group user identifiers; a sub-set of parameters associated with the shared group access parameter indicating the privileges that group users will have with respect to the list including list view privileges, list item edit privileges, and list item delete privileges; and a check-out time parameter associated with the shared group access parameter indicating how long a group user can maintain exclusive access to the list.

4. The method of claim 3 wherein the list items are one or more of a text item, an audio item, a picture item, a video item, a multimedia item, and a URL item.

5. The method of claim 4 wherein creating one or more list items associated with the list comprises:
selecting a category;
selecting a list within the selected category; and
appending an item to the selected list within the selected category wherein the item to be appended is based on input entered into the mobile communications device, the input being one or more of a text item, an audio item, a picture item, a video item, a multimedia item, and a URL item.

6. The method of claim 4 wherein creating one or more list items associated with the list comprises:
receiving a message in the mobile communications device, the message containing a group user identifier, a category name, a list name, and an item to be appended to the list associated with the list name;
determining the category name from the received message;
determining the list name from the received message;
verifying the message was sent from an authorized group user based on the access group user parameter and the group user identifier; and
if verified, appending the item included with the received message to the selected list within the selected category wherein the item to be appended is one of a text item, an audio item, a picture item, a video item, a multimedia item, and a URL item.

7. The method of claim 4 wherein creating one or more list items associated with the list comprises:
selecting an item from an other application currently executing in the mobile communications device;
selecting a category;
selecting a list within the selected category; and
appending the selected item from the other application to the selected list within the selected category wherein the item to be appended is based on input entered into the mobile communications device, the input being one of a text item, an audio item, a picture item, a video item, a multimedia item, and a URL item.

8. The method of claim 4 further comprising checking a list out to a group user comprising:
receiving, from a group user, a list access request for a specified list from a specified category;
verifying that the group user has access to the list based on the group user identifier;
determining the privileges afforded to the group user requesting the list; and
forwarding a view only copy of the requested list to the group user if the group user privileges do not afford more than view only access; otherwise
forwarding an editable copy of the requested list to the group user.

9. The method of claim 8 wherein checking a list out to a group user further comprises including a check-out time parameter associated with the shared group access parameter indicating how long a group user can maintain exclusive access to the list.

10. The method of claim 4 further comprising checking a list in from a group user comprising:
receiving, from a group user, a list to be checked back in;
verifying that the group user has access to the list based the group user identifier, category name, and list name; and
checking the list back in.

11. The method of claim 10 wherein checking a list in from a group user further comprises:
determining whether a timeout parameter that indicates how long the group user can hold the list before checking it back in has expired; and
checking the list back in only if the timeout parameter has not expired thereby allowing access to the list to other group users.

12. A computer readable medium storing a computer program product for creating and managing a category based list in a mobile communications device, the computer readable medium comprising:
computer program code for creating a category with an assigned a category name;
computer program code for creating a list with an assigned list name associated with a category name; and
computer program code for defining a set of parameters governing the list.

13. The computer readable medium of claim 12 further comprising computer program code for creating one or more list items associated with the list.

14. The computer readable medium of claim 13 wherein the set of parameters governing the list include one or more of a list expiration date; a group access parameter indicating whether the list is private or shared among one or more group users; one or more group user identifiers; a sub-set of parameters associated with the shared group access parameter indicating the privileges that group users will have with respect to the list including list view privileges, list item edit privileges, and list item delete privileges; and a check-out time parameter associated with the shared group access parameter indicating how long a group user can maintain exclusive access to the list.

15. The computer readable medium of claim 14 wherein the list items are one or more of a text item, an audio item, a picture item, a video item, a multimedia item, and a URL item.

16. The computer readable medium of claim 15 wherein the computer program code for creating one or more list items associated with the list comprises:
computer program code for selecting a category;
computer program code for selecting a list within the selected category; and
computer program code for appending an item to the selected list within the selected category wherein the item to be appended is based on input entered into the mobile communications device, the input being one or more of a text item, an audio item, a picture item, a video item, a multimedia item, and a URL item.

17. The computer readable medium of claim 15 wherein the computer program code for creating one or more list items associated with the list comprises:
computer program code for receiving a message in the mobile communications device, the message containing a group user identifier, a category name, a list name, and an item to be appended to the list associated with the list name;
computer program code for determining the category name from the received message;
computer program code for determining the list name from the received message;
computer program code for verifying the message was sent from an authorized group user based on the access group user parameter and the group user identifier; and
if verified, computer program code for appending the item included with the received message to the selected list within the selected category wherein the item to be appended is one of a text item, an audio item, a picture item, a video item, a multimedia item, and a URL item.

18. The computer readable medium of claim 15 wherein the computer program code for creating one or more list items associated with the list comprises:
computer program code for selecting an item from an other application currently executing in the mobile communications device;
computer program code for selecting a category;
computer program code for selecting a list within the selected category; and
computer program code for appending the selected item from the other application to the selected list within the selected category wherein the item to be appended is based on input entered into the mobile communications device, the input being one of a text item, an audio item, a picture item, a video item, a multimedia item, and a URL item.

19. The computer readable medium of claim 15 further comprising computer program code for checking a list out to a group user comprising:
computer program code for receiving, from a group user, a list access request for a specified list from a specified category;
computer program code for verifying that the group user has access to the list based on the group user identifier;
computer program code for determining the privileges afforded to the group user requesting the list; and
computer program code for forwarding a view only copy of the requested list to the group user if the group user privileges do not afford more than view only access; otherwise
computer program code for forwarding an editable copy of the requested list to the group user.

20. The computer readable medium of claim 19 wherein the computer program code for checking a list out to a group user further comprises computer program code for including a check-out time parameter associated with the shared group access parameter indicating how long a group user can maintain exclusive access to the list.

21. The computer readable medium of claim 15 further comprising computer program code for checking a list in from a group user comprising:
computer program code for receiving, from a group user, a list to be checked back in;
computer program code for verifying that the group user has access to the list based the group user identifier, category name, and list name;
computer program code for determining whether a timeout parameter that indicates how long the group user can hold the list before checking it back in has expired; and
computer program code for checking the list back in.

22. The computer readable medium of claim 21 wherein the computer program code for checking a list in from a group user further comprises:
computer program code for determining whether a timeout parameter that indicates how long the group user can hold the list before checking it back in has expired; and
computer program code for checking the list back in only if the timeout parameter has not expired thereby allowing access to the list to other group users.

23. A system for creating and managing a category based list in a mobile communications device comprising:
a processor;
a display coupled with the processor;
a storage device coupled with the processor;
a user interface coupled with the processor;
an RF module coupled with the processor; and
a category based list control software application coupled with and under control of the processor for:
creating a category with an assigned a category name;
creating a list with an assigned list name associated with a category name; and
defining a set of parameters governing the list.

24. The system of claim 23 wherein the category based list control software application further comprises creating one or more list items associated with the list.

25. The system of claim 24 wherein the set of parameters governing the list include one or more of a list expiration date; a group access parameter indicating whether the list is private or shared among one or more group users; one or more group user identifiers; a sub-set of parameters associated with the shared group access parameter indicating the privileges that group users will have with respect to the list including list view privileges, list item edit privileges, and list item delete privileges; and a check-out time parameter associated with the shared group access parameter indicating how long a group user can maintain exclusive access to the list.

26. The system of claim 25 wherein the list items are one or more of a text item, an audio item, a picture item, a video item, a multimedia item, and a URL item.

27. The system of claim 26 wherein the category based list control software application further comprises creating one or more list items associated with the list and comprises:
selecting a category;
selecting a list within the selected category; and
appending an item to the selected list within the selected category wherein the item to be appended is based on input entered into the mobile communications device, the input being one or more of a text item, an audio item, a picture item, a video item, a multimedia item, and a URL item.

28. The system of claim 26 wherein the category based list control software application further comprises creating one or more list items associated with the list and comprises:
receiving a message in the mobile communications device, the message containing a group user identifier, a category name, a list name, and an item to be appended to the list associated with the list name;
determining the category name from the received message;
determining the list name from the received message;
verifying the message was sent from an authorized group user based on the access group user parameter and the group user identifier; and
if verified, appending the item included with the received message to the selected list within the selected category wherein the item to be appended is one of a text item, an audio item, a picture item, a video item, a multimedia item, and a URL item.

29. The system of claim 26 wherein the category based list control software application further comprises creating one or more list items associated with the list and comprises:
selecting an item from an other application currently executing in the mobile communications device;
selecting a category;
selecting a list within the selected category; and
appending the selected item from the other application to the selected list within the selected category wherein the item to be appended is based on input entered into the mobile communications device, the input being one of a text item, an audio item, a picture item, a video item, a multimedia item, and a URL item.

30. The system of claim 26 wherein the category based list control software application further comprises checking a list out to a group user comprising:
receiving, from a group user, a list access request for a specified list from a specified category;
verifying that the group user has access to the list based on the group user identifier;
determining the privileges afforded to the group user requesting the list; and
forwarding a view only copy of the requested list to the group user if the group user privileges do not afford more than view only access; otherwise
forwarding an editable copy of the requested list to the group user.

31. The system of claim 30 wherein the category based list control software application further comprises including a check-out time parameter associated with the shared group access parameter indicating how long a group user can maintain exclusive access to the list.

32. The system of claim 26 wherein the category based list control software application further comprises checking a list in from a group user comprising:
receiving, from a group user, a list to be checked back in;
verifying that the group user has access to the list based the group user identifier, category name, and list name;
determining whether a timeout parameter that indicates how long the group user can hold the list before checking it back in has expired; and
checking the list back in.

33. The system of claim 32 wherein the category based list control software application further comprises:
determining whether a timeout parameter that indicates how long the group user can hold the list before checking it back in has expired; and
checking the list back in only if the timeout parameter has not expired thereby allowing access to the list to other group users.
